(19) United States
(12) Patent Application Publication
(10) Pub. No.: US 2026/0008946 A1
(43) Pub. Date: Jan. 8, 2026

(54) Photo-curable Acrylate Adhesives for Plastic Bonding

(71) Applicant: Henkel AG & Co. KGaA, Duesseldorf (DE)

(72) Inventors: Shuhua Jin, Cheshire, CT (US); Chih-Min Cheng, Westford, MA (US); James Bernhardt, Middletown, CT (US)

(21) Appl. No.: 19/324,350

(22) Filed: Sep. 10, 2025

Related U.S. Application Data
(63) Continuation of application No. PCT/US2024/018764, filed on Mar. 7, 2024.
(60) Provisional application No. 63/493,455, filed on Mar. 31, 2023.

(51) Int. Cl. C09J 151/08; C08F 290/06

(52) U.S. Cl. CPC C09J 151/08; C08F 290/061

(57) ABSTRACT

The present invention relates to photo-curable (meth)acrylate compositions which when cured have high lap shear strength and/or exhibit low extraction or no detectable extracted acrylic monomer or monomer components which are on the GHS list. The compositions include a novel caprolactone-based polyurethane (meth)acrylate oligomer which is used to formulate photo-curing compositions useful for bonding substrates, especially plastic substrates. The compositions are suitable for use as adhesives, sealants or coatings on many substrates.

### BACKGROUND

### Field

In one embodiment the present invention relates to photo-curable (meth)acrylate compositions which when cured exhibit low extraction of hazardous and/or harmful acrylic monomer compounds. The compositions include a caprolactone-based polyurethane (meth)acrylate oligomers, one or more di-functional methacrylate monomers and photoinitiators. The compositions are suitable for use as inks, adhesives, sealants or coatings.

### Brief Description Related Technology

Urethane acrylate compounds are often used in light cured, adhesives, inks, coatings and sealants. Light cured or photo-cured compositions are compositions curable using radiation such as visible or ultraviolet light (UV). It is desirable for these compositions to have a balance of molecular weight and viscosity, in order to be applied effectively. Additionally, for better workability, reactive acrylic diluents are often added. These acrylic monomers are generally low molecular weight, polar compounds which do not always incorporate fully into the polymerized composition and can leach out in time, causing potentially harmful and/or hazardous exposure to humans.

For example, current commercially available (meth)acrylate-based photo-curable compositions generally contain only low molecular weight acrylates such as isobornyl (meth)acrylate (IBOA M.W. 222.32) and N, N-dimethylacetamide (N,N′-DMA M.W. 87.12), or epoxy monomers which might not be desirable for some applications. Notwithstanding the fact that photo-curing and crosslinking of these compositions takes place rapidly, unreacted monomers, or monomer components and impurities, still may leach out, or they may be extracted under certain conditions, presenting potential problems for certain uses.

One way to address this problem is to use monomers with higher molecular weights, but this approach generally leads to lower reactivity and often has a negative impact on properties, such as viscosity and adhesion strength to different substrates. Thus, most commercially available photo-curable acrylate products use low molecular weight (meth)acrylate monomers and will require labeling as corrosive and harmful Globally Harmonized System (GHS) in their safety data sheet (SDS) profiles.

### SUMMARY

It would be advantageous to find a (meth)acrylate-based photo-curable composition which has a workable viscosity and once cured has desirably high adhesion strength and/or a low amount of unreacted, extractable (meth)acrylate monomers. The present invention provides such a solution by forming the photo-curable oligomer component using monomers which is not considered a chemical hazard, and, in some embodiments, either eliminating or substantially minimizing other potential extractables from the final photo-curable composition. GHS is a regulation managed by the United Nations for classifying and communicating chemical hazards. This composition is not a pressure-sensitive adhesive and would not be suitable for use as a pressure sensitive adhesive.

One aspect of the invention includes, a photo-curable composition comprising:
a) a caprolactone-based polyurethane (meth)acrylate oligomer;
b) a monofunctional or polyfunctional (meth)acrylate monomer; and
c) a photoinitiator.

One aspect of the invention includes, a photo-curable composition comprising:
a) a caprolactone-based polyurethane (meth)acrylate oligomer;
b) a poly-functional polyether (meth)acrylate monomer; and
c) a photoinitiator;
wherein the resultant photo-curable composition once photo-cured exhibits low amount of extracted (unreacted) component.

One aspect of the invention includes, a photo-curable composition comprising:
a) a caprolactone-based polyurethane (meth)acrylate oligomer present in amount of about 20% to about 60% by weight of the total composition;
b) a poly-functional polyether (meth)acrylate monomer present in amount of about 10% to about 60% by weight of the total composition; and
c) a photoinitiator, present in amounts of about 0.2% to about 5% by weight of the total composition; and wherein the ratios of the oligomer/poly-functional Polyether (meth)acrylate may range from about 30/70 to about 70/30, from about 35/65 to about 65/35, from about 45/55 to about 55/45, from about 40/60 to about 60/40, and about and wherein the resultant photo-curable composition once photo-cured exhibits substantially no detectible extracted (unreacted) component.

In another aspect of the invention, there is included a process for preparing a photo-curable composition comprising:
a) preparing a caprolactone-based polyurethane (meth)acrylate oligomer by reacting a mono-(meth)acrylate monomer containing a hydroxyl group and a hexamethylene diisocyanate (HDI) isocyanurate; and
b) combining the reaction product of step a), with a polyfunctional polyether (meth)acrylate monomer and a photoinitiator.

In another aspect of the invention, there is included a method of forming an adhesive, coating, or a sealant, by applying the photo-curable composition thus formed, to a substrate, exposing it to UV or visible light and permitting the composition to crosslink and cure. Articles of manufacture incorporating the composition as a layer, a coating, a bond, an adhesive or a sealant are also included.

### DETAILED DESCRIPTION

### Definitions

The term “oligomer” as used herein refers to relatively low molecular weight polymeric compounds which include at least two monomer units linked to each other. Desirably the oligomer includes from 2 to 1000 monomer units linked to each other, and more desirably 2 to 300 monomer units, or 2 to 200 monomer units or 2 to 100 monomer units, or 2 to 50 monomer units or 2 to 40 monomer units, or 2 to 30 monomer units, or 2 to 20 monomer units, or 2 to 10 monomer units, or 1 to 5 monomer units linked to each other.

The term “(meth)acryl” as used herein indicates acryl, methacryl or any combination thereof. Similarly, the term “(meth)acryloxy” indicates acryloxy, methacryloxy or any combination thereof; the term “(meth)acrylic acid” indicates acrylic acid, methacrylic acid or any combination thereof; the term “(meth)acrylate” indicates acrylate, methacrylate or any combination thereof; and the term “(meth)acrylamide” indicates acrylamide, methacrylamide or any combination thereof. The number of the (meth)acryl groups in the (meth)acrylate usable in the present invention is not particularly limited and can be one or more.

The terms “extracted,” “extractable” or “extractables” mean any unreacted monomer, monomer residue or monomer component (for example a monomer impurity), that is extractable subsequent to cure, or which leaches out over time subsequent to cure. Extractable components may be present in trace amounts as long as they are not in amounts which would be considered hazardous or cause sensitivities to humans, but desirably no extractables are detectable in the compositions of the present invention.

The term molecular weight (“M.W.”) means the average weight fraction of molecules in a sample. Molecular weight data can be obtained in known ways such as by gel permeation chromatography (GPC) calibrated against polystyrene standards in accordance with DIN 55672-1:2007-08. The number average molecular weight Mn can be determined by the same methods.

This invention provides, rapid photo-curable (meth)acrylate containing compositions which, in one embodiment, include a caprolactone-based polyurethane (meth)acrylate oligomer made from the reaction of a mono-(meth)acrylate monomer containing one or more hydroxyl terminal group(s) and hexamethylene diisocyanate (HDI) isocyanurate; a functional (meth)acrylate monomer and photoinitiators. The oligomers used in the compositions have relatively low viscosities by themselves, which facilitate the formation of desirable low viscosities in the photo-curable compositions to which they are added.

### Useful Oligomers

The caprolactone-based polyurethane (meth)acrylate oligomer comprises the reaction product of a mono-(meth)acrylate monomer containing a hydroxyl group comprising a caprolactone-containing (meth)acrylate monomer and hexamethylene diisocyanate (HDI) isocyanurate or biuret. Examples of this oligomer include Capa-1 (reaction product of HDI isocyanurate and hydroxy terminated polycaprolactone acrylate) and Capa-2 (reaction product of HDI biuret and hydroxy terminated polycaprolactone acrylate)

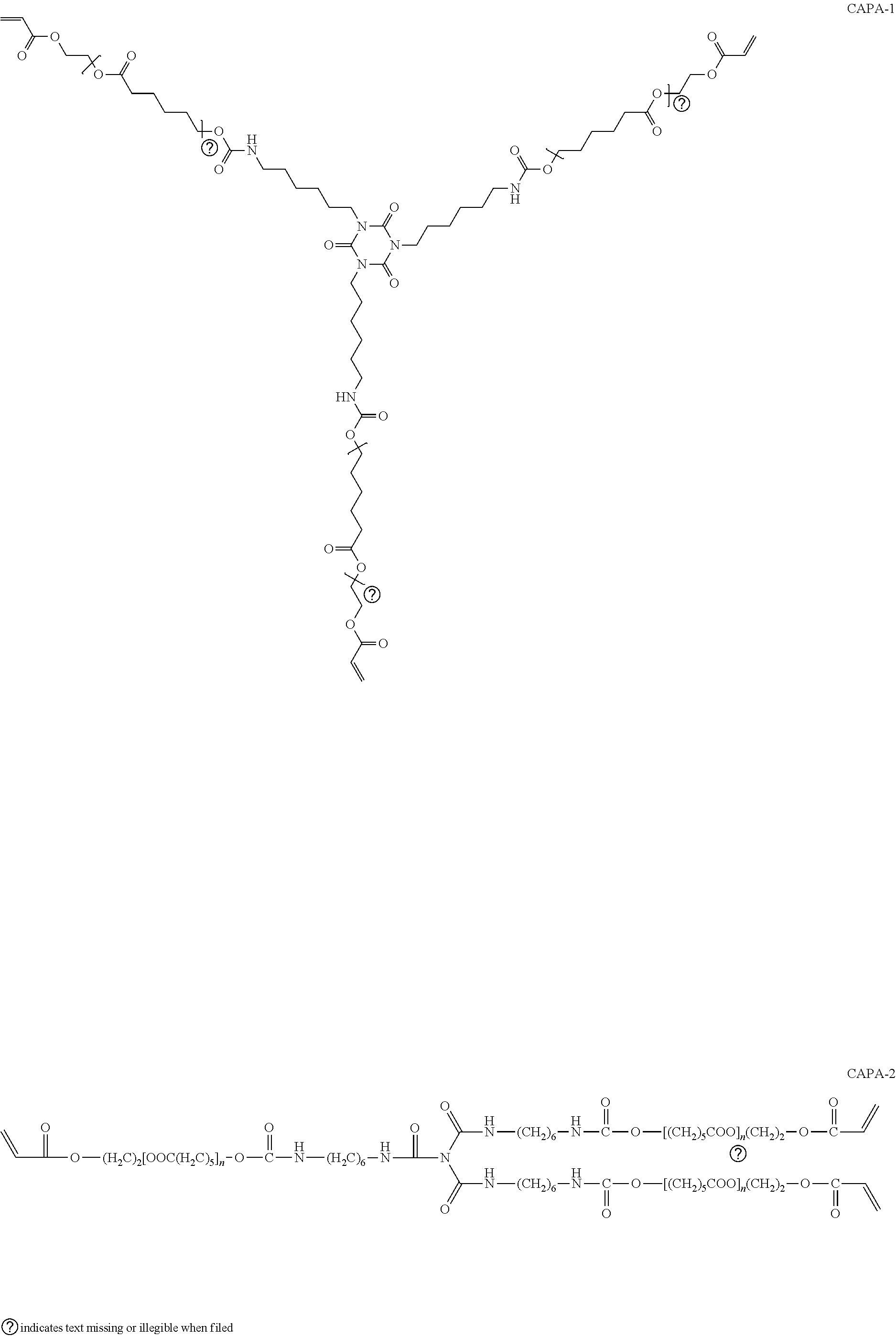

Mono(meth)acrylate monomers, such as caprolactone-containing monomers, will have a GHS label. However, these materials are fully reacted in the cured product and will not have an extractable content.

The caprolactone-based polyurethane (meth)acrylate oligomer is present in the amount of about 20% to about 60%, about 25% to about 60%, about 30% to about 60%, about 35% to about 608, about 40% to about 608, about 45% to about 608, about 50% to about 60%, about 55% to about 60%; or about 20% to about 55%, about 25% to about 55%, about 30% to about 55%, about 35% to about 558%, about 40% to about 55%, about 45% to about 55%, about 50% to about 60%, about 55% to about 608, all percentages by weight of the total composition.

### Functional (Meth)Acrylate Monomer

The composition comprises a functional (meth)acrylate monomer. The functional (meth)acrylate monomer is preferably polyfunctional having two or three or more functional (meth)acrylate moieties. Functional (meth)acrylate monomers include low molecular weight polyfunctional (meth)acrylate monomers and polyfunctional polyether (meth)acrylate monomers.

Useful poly-functional polyether (meth)acrylate monomers may be selected from the group consisting of polyethylene glycol dimethylacrylate (PEG200 DMA), dipropylene glycol diacrylate, triethylene glycol di-(meth)acrylate, trimethylol propane tri (meth)acrylate, tetrahydrodicyclopentadienyl (meth)acrylate, ethoxylated trimethylol propane triacrylate (“ETTA”), triethylene glycol diacrylate and triethylene glycol dimethacrylate (“TRIEGMA”) and combinations thereof. In one aspect of the invention, poly-functional polyether (meth)acrylate monomers with an average molecular weight above a certain range may be selected. In one aspect of the invention, poly-functional polyether (meth)acrylate monomers with an average molecular weight of equal to or greater than 300 are desirable.

The poly-functional polyether (meth)acrylate monomers may be present in amounts of about 10% to about 60%, about 15% to about 60%, about 20% to about 60%, about 25% to about 60%, about 30% to about 60%, about 35% to about 608, about 40% to about 60%, about 45% to about 60%, about 50% to about 60%; or about 10% to about 55%, about 15% to about 558, about 20% to about 55%, about 20% to about 55%, about 25% to about 55%, about 30% to about 55%, about 35% to about 55%, about 40% to about 55%, about 45% to about 55%, about 50% to about 55%; all percentages based on the weight of the total composition.

As shown in the examples, various ratios of oligomer to poly-functional polyether (meth)acrylates have specific advantages with respect to the viscosity of the photo-curable compositions and their physical properties when cured. For example, ratios of the oligomer/poly-functional polyether (meth)acrylate may range from about 30/70 to about 70/30 (e.g. 28/72 to 72/28), from about 35/65 to about 65/35, from about 45/55 to about 55/45, from about 40/60 to about 60/40, and about 50/50. At higher ratios of oligomer to poly-functional Polyether (meth)acrylates, lower viscosities and higher tensile properties on plastic substrates were exhibited. Conversely, at higher ratios of the poly-functional Polyether (meth)acrylates to oligomer, higher viscosities and lower tensile strengths were exhibited.

### Photoinitiators

Photoinitiators useful in the present invention include, but are not limited to UV initiators, visible initiators, or a combination of UV and visible initiators. In one aspect of the present invention, the photoinitiator may be a polymeric structure to which is attached at least one chromophore that is excited by radiation in the UV light or visible light range.

A variety of UV initiators may be employed in any of the inventive compositions. UV initiators are generally effective in the 200 to 400 nm range, and particularly in the portion of the spectrum that borders on the invisible light and the visible portion just beyond this, e.g. >200 nm to about 390 nm.

Among the useful initiators that will respond to UV radiation to initiate and induce curing of the (meth)acryl functionalized curable component include, but are not limited to, benzophenone and substituted benzophenones, acetophenone and substituted acetophenones, benzoin and its alkyl esters, xanthone and substituted xanthones, phosphine oxides, diethoxyacetophenone, benzoin methylether, benzoin ethylether, benzoin isopropylether, diethoxyxanthone, chlorothioxanthone, N-methyldiethanol-amine-benzophenone, 2-hydroxy-2methyl-1-phenyl-propan-1-one, 2-benzyl-2-(dimethylamino)-1-[4-(4-morpholinyl)phenyl]-1-butanone and mixtures thereof.

Examples of such UV initiators include initiators available commercially from IGM Resins under the “OMNIRAD” (formerly “IRGACURE”) and “DAROCUR” trade names, specifically “OMNIRAD” 184 (1-hydroxycyclohexylphenylketone), 907 (2-methyl-1-[4-(methylthio)phenyl]-2-morpholinopropan-1-one), 369 (2-benzyl-2-N, Ndimethylamino-1-(4-morpholinophenyl)-1-butanone), 500 (the combination of 1-hydroxcyclohexyl phenylketone and benzophenone), 651(2,2-dimethoxy-2-phenylacetophenone), 1700 (the combination of bis(2,6-dimethoxybenzoyl-2,4,4-trimethylpentyl) phosphine oxide and 2-hydroxy-2-methyl-1-phenyl-propan-1-one), 819 [bis(2,4,6,6-trimethylbenzoylphenyl phosphine oxide], “DAROCUR” 1173 (2-hydroxy-2-methyl-1-phenyl-1-propane) 4265 (the combination of 2,4,6-trimethylbenzoyldiphenyl-phosphineoxide and 2-hydroxy-2-methyl-1phenyl-propan-1-one); and 2,4,6-trimethylbenzoyldiphenylphosphine oxide (commercially available as LUCIRIN TPO from BASF Corp.).

Visible light initiators suitable for use in the present invention include, but are not limited to, camphorquinone peroxyester initiators, 9-fluorene carboxylic acid peroxyesters, visible light [blue] photoinitiators, dl-camphorquinone, “IRGACURE” 784DC (photoinitiator based on substituted titanocenes), and combinations thereof.

Any of the aforementioned photoinitiators may be used in the compositions of the invention in amounts of about 0.2% to about 5%, and desirably about 0.5% to about 3% by weight of the total composition.

### Optional Additives

In some embodiments the photo-curable compositions may optionally include functional low molecular weight (meth)acrylate monomers additional to, and different from, the caprolactone-based polyurethane (meth)acrylate oligomer or the functional (meth)acrylate monomer. These additional (meth)acrylate monomers can be used, for example, to tailor a specific property of the uncured composition or cured reaction products of the composition. In some embodiments the low molecular weight (meth)acrylate monomers, are monofunctional to limit cross-linking of the composition. If extractable material content is a concern care must be taken not to add low molecular weight (meth)acrylate monomers that would create or increase the potential for extractable material to be present subsequent to cure.

In some embodiments it may be desirable to have none, or mere trace amounts of, or nearly undetectable amounts of, (meth)acrylate monomer extractables. This can be accomplished by not using, or limiting the amount of, low molecular weight (meth)acrylate monomers in the composition. In other applications the amount of (meth)acrylate monomer extractables will be of lesser concern, allowing use of more low molecular weight (meth)acrylate monomers. The low molecular weight (meth)acrylate monomers do not take the place of the caprolactone-based polyurethane (meth)acrylate oligomer or the functional (meth)acrylate monomer.

Low molecular weight (meth)acrylate monomers include molecules having one or two or three or more functional (meth)acrylate moieties and a molecular weight of 500 or less, more usually 400 or less and more typically 250 or less or 150 or less. Low molecular weight (meth)acrylate monomers include mono-functional monomers such as hydroxyethyl (meth)acrylate (HEA or HEMA), Hydroxypropyl (meth)acrylate (HPA or HPMA); isobornyl (meth)acrylate (IBOA or IBOMA). As indicated, these monomers will not take the place of the required oligomer and poly-functional Polyether (meth)acrylates, but if present in minor amounts may be acceptable for certain applications and if the final cured compositions show substantially low or are essentially free extractable components. Keeping this caveat in mind, other conventional acrylic monomers may be incorporated as desired to achieve specific properties.

Additional low molecular weight (meth)acrylate monomers include, but are not limited to, (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl) trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate. In an aspect of the present invention, the (meth)acrylate monomer is polyethylene glycol diacrylate, such as SR 259 (polyethylene glycol (200) diacrylate from Sartomer). Suitable multifunctional (meth)acrylates include, but are not limited to, polyethylene glycol di(meth)acrylates, desirably triethyleneglycol di(meth)acrylate, hydroxypropyl (meth)acrylate, bisphenol-A di(meth)acrylates, such as ethoxylated bisphenol-A (meth)acrylate (“EBIPA” OR “EBIPMA”), and tetrahydrofuran (meth)acrylates and di(meth)acrylates, citronellyl acrylate and citronellyl methacrylate, hexanediol di(meth)acrylate (“HDDA” or “HDDMA”), trimethylol propane tri (meth)acrylate, tetrahydrodicyclopentadienyl (meth)acrylate, ethoxylated trimethylol propane triacrylate (“ETTA”), triethylene glycol diacrylate and triethylene glycol dimethacrylate (“TRIEGMA”).

Catalysts are optional but may be desirably incorporated into the inventive compositions in amounts useful in the formation of the oligomers, and/or incorporated into the polymer compositions as a whole.

Among the useful catalysts include organometallic catalysts. The organometallic catalysts desirably include stannous octoate, dibutyltin dilaurate and dibutyltin diacetate. One particularly desirable catalyst is dibutyltin dilaurate (DBTL).

For example useful amounts of a catalyst include about 0.01 percent by weight to about 1.0 percent by weight of the total composition, and desirably in amounts of about 0.01 percent by weight to about 0.05 percent by weight of the total composition.

Optional additives, such as, but not limited to, fluorescence additives, fillers, rheology modifiers, photosensitizers, coloring agents, accelerators, adhesion promoters, defoamers, stabilizers, antioxidants and pigments and combinations thereof may be included in the compositions of the present disclosure.

Suitable fillers include organic and inorganic ones. Inorganics include silica, silicate, alumina, barium sulphate, calcium carbonate, calcium fluoride, carbon black, clays, diatomaceous earth, feldspar, ferromagnetics, fly ash, glass bubbles, glass fibers, gypsum, jute fiber, kaolin, lingnocellulosics, magnesium hydroxide, mica, microcrystalline cellulose, powdered metals, quartz, starch, talc, titanium dioxide, wood flour, wood fibers, and combinations thereof. Organic fillers include thermoplastic polymers, for example polymeric microspheres, polyvinylacetates, polyolefins, and nylon fibers.

Fillers are optional and if used may be incorporated into any of the compositions for desired properties and as such may be present in the amount of about 0.1% to about 30%, and desirably about 5% to about 20% percent by weight of the total composition.

Optionally, organic rheology modifiers may be incorporated into any of the inventive compositions for desired properties and as such may be present in the amount of about 1% to about 10%, and desirably about 2% to about 6% percent by weight of the total composition.

Optionally, stabilizers may be incorporated into any of the inventive compositions for desired properties and as such may be present in the amount of about 0.1% to about 2%, and desirably about 0.5% to about 18 percent by weight of the total composition.

Optionally, antioxidants may be incorporated into any of the inventive compositions for desired properties and as such may be present in the amount of about 0.1% to about 2%, and desirably about 0.5% to about 1% percent by weight of the total composition.

Optionally, defoamers may be incorporated into any of the inventive compositions for desired properties and as such may be present in the amount of about 0.1% to about 2%, and desirably about 0.5% to about 18 percent by weight of the total composition.

The synthesized photo-curable (meth)acrylate compositions of the present invention may be used as adhesives, coatings, inks and sealants for substrates and exhibit particularly excellent properties on plastic substrates.

Articles of manufacture which are useful with the compositions of the present invention include a variety of plastics such as polycarbonate (PC), polyvinylchloride (PVC), acrylonitrile butadiene styrene (ABS), thermoplastic urethane (TPU), (meth)acrylate and (meth)acrylate copolymers, epoxy and reinforced epoxy composites such as such as G10/FR4 glass fiber epoxy composite. In some embodiments the photo-curable (meth)acrylate compositions of this invention show workable viscosity ranges (especially low viscosities relative to readily available comparable commercial products), and good adhesion to plastic substrates such as polycarbonate (PC), polyvinylchloride (PVC), acrylonitrile butadiene styrene (ABS), as well as substrates commonly used in electronic devices, such as G10/FR4 glass epoxy composite materials. The disclosed compositions are not expected to provide optimum bond strength for metal, paper or ceramic substrates.

In one aspect of the invention, there is included an article of manufacture which incorporates the inventive compositions and the process of incorporating the compositions in such an article. For example, an article of manufacture is contemplated which includes a first plastic substrate surface and a second plastic or metal substrate surface, said first and second substrate surfaces adhesively joined by the formation of a bond using the photo-curable compositions of the invention. The plastic substrates enumerated herein are contemplated for such articles.

The photo-curable compositions of this invention find a balance of workable relatively low viscosities, excellent physical properties such as adhesion strength, and in some embodiments low or no detectable extractability (or leaching out) of harmful/hazardous compounds, for example low molecular weight (meth)acrylate monomers.

The photo-curable compositions generally have a Shore D hardness of about 50 to about 95, 50 to about 85, 50 to about 80, 50 to about 75, 50 to about 70, 50 to about 65, 50 to about 60; or about 55 to about 95, about 55 to about 90, about 55 to about 85, about 55 to about 80, about 55 to about 75, about 55 to about 70, about 55 to about 65, about 55 to about 60, about 60 to about 95, about 60 to about 90 about 60 to about 85, about 60 to about 80, about 60 to about 75, about 60 to about 70, about 60 to about 6; or 65 to about 95, 65 to about 90, 65 to about 85, 65 to about 80, 65 to about 75, 65 to about 70; or 70 to about 95, or 70 to about 90, or 70 to about 85, or 70 to about 80, or 70 to about 75, or 70 to about 65, or 70 to about 60; or 75 to about 95, 75 to about 90, 75 to about 85, 75 to about 80; or 80 to about 95, 80 to about 90, or 85 to about 95.

The photo-curable compositions of the invention may have a thixotropic index (TI) of about 2 to about 10, and desirably about 2 to about 7 cps at 1 s−1/cps at 10 s−1. As used herein, the term “thixotropic index” means the ratio of the viscosity (in centipoise) of the curable composition at a speed of 1 sec-1 to the viscosity (in centipoise (cps)) of the curable composition at a speed of 10 sec−1 (viscosity at 1 s−1/viscosity at 10 s−1)). The viscosity may be determined using known methods, for example, cone and plate rheometer, parallel plate rheometer, or rotation viscometer, such as Brookfield viscometer.

In one aspect of the invention, the photo-curable composition has a viscosity of about 200 to about 10,000 Cps, 300 to about 7,000 Cps. and desirably 500 to about 5,000 Cps.

In one aspect of the present invention, the photo-curable composition may be cured using a radiation source, such as a bulb or LED that produces visible or UV light. Curing would also be possible using exposure to electrons from a beam source.

In one embodiment cured reaction products of these compositions have a PC/PC lap shear strength of 4 MPa and/or a PC/PVC lap shear strength of 5 MPa. These strengths are surprising as similar compositions did not provide these strength levels.

In one embodiment cured reaction products of the composition have extractable amounts of low molecular weight (meth)acrylate monomers below desired limits. For some applications where exposure is a concern a limit of 50 ppm by weight or less or 25 ppm or less or 10 ppm or less or even non detected is desirable. In other applications higher limits of extractable low molecular weight (meth)acrylate monomers such as 100 ppm or less or 250 ppm or less or 500 ppm or less or 1,000 ppm or less may be acceptable. In some applications the level of low molecular weight (meth)acrylate monomer extractables will be of no concern

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

### EXAMPLES

### Testing Methods

Examples 1-6 were evaluated according to the testing conditions described herein below.

### Viscosity

Viscosities were measured at a shear rate of 1 s−1 and 10 s−1 using a cone and plate rheometer (Anton Paar). Thixotropic Index (TI) was calculated as the ratio of viscosities 1 s−1 and 10 s−1.

### Shore D Hardness

Shore D samples were measured based on ASTM D2240. The light curable composition was placed between two plastic sheets with a 1 mm thick spacer, and light cured for 10 seconds on each side using Henkel EQ CL20 LED Flood 405 nm with a light intensity of 1.2 w/cm2. The cured sheet was cut into 20 mm long and 10 mm wide rectangular specimen.

### Lap Shear Strength

Tensile lap shear was tested per ASTM D3163. Four types of lap shear substrates were tested: Polyvinylchloride (PVC, 25×100×1.5 mm) from ThyssenKrupp Material NA, Polycarbonate (PC, 25×100×3 mm) UV Trans Grade from Kariega, a glass fiber reinforced epoxy substrate available as Epoxy FR-4 or G-10 Epoxy Glass (25×100×1.5 mm) from Curbell Plastics, and Acrylonitrile butadiene styrene (ABS, 25×100×1.5 mm) from ThyssenKrupp Material NA. The substrates were cleaned with isopropyl alcohol to remove dirt and oils. The inventive compositions were applied as an adhesive to a portion of the substrate surface and then covered with UV Trans Grade PC to create a bonding area of 25×12.7 mm (1×0.5 inch) with zero gap. The bonding area was then light cured for 30 seconds on top of the PC substrate using Henkel EQ CL20 LED Flood 405 nm with light intensity of 1.0 w/cm2. The lap shear samples were tested on a lap shear pulling machine with a pulling speed of 0.08 inch/minute. The tensile strength at maximum load was recorded. The provided strengths for each composition are an average of results for 6 lap shear specimens.

### (Meth)Acrylate Monomer Extraction Test Sample Preparation and Test

About 4 to 5 g of the light curable compositions (both comparative and inventive as show below) was placed between two 6×8 mm size polyethylene (PE) sections cut from sheets with a thickness of 0.75 mm, and then light cured for 20 seconds on each side using a Henkel EQ CL20 LED Flood 405 nm with light intensity of 1.0 w/cm2. The PE films were removed and the cured adhesive was cut into strips of approximately 1×2 cm and placed in a 3-dram glass vial. Strips were added to the vial until the nominal aggregate weight was 2 grams. The vial was filled with 7 ml of acetone and 250 ul of a 2500-ppm decane internal standard solution was added. The vials were placed in an incubator and held at 38° C. for 24 hours.

The amount of (meth)acrylate monomer was measured using a GC/MS instrument (example, Agilent 7890B GC, 5977A MSD, and a 7650 ALS) with an Agilent HP-5 MS column (30 m×0.25 mm, 0.25 micron). The sample was introduced into the GC via a 25:1 split injection. The GC oven was held at 40° C. for 4 minutes, ramped to 280° C. at 10° C./minute, then held for 10 minutes. The column flow rate was held constant at 1 ml/minute producing a retention time for decane of 10.4 minutes. The mass spectrometer was operated in electron impact mode at 70 eV with a mass scan range of 35-550 amu. The total ion chromatogram (TIC) was generally used for quantitation, however, extracted ion processing may be employed for complex chromatograms where analyte coelution occurs or for purposes of enhancing sensitivity. In these situations, m/z 57 was the characteristic ion used for decane while characteristics ions for analytes were chosen based on their mass spectra. Selective ion monitoring (SIM) may be utilized for sensitivity purposes. Typically, a level of 50 ppm or less is considered acceptable for sensitive applications.

The amount of an analyte extracted from a sample was calculated by Cx=((AxCis)/Ais)*(Vs/Wt.) where:
Cx=concentration of an analyte extracted from a film (ug/g)
Cis=concentration of the internal standard (ug/ml)
Ax=peak area of the analyte
Ais=peak area of the internal standard
Vs=volume of extraction solvent (ml) in 3-dram vial
Wt.=aggregate weight of cured film extracted (g)

### Materials

Light curable acrylate materials used in all the examples:

| Name | Category | Supplier |
|---|---|---|
| Photomer 6019 | Aliphatic urethane | IGM |
| | triacrylate | |
| Photomer 6008 | Aliphatic urethane | IGM |
| | triacrylate | |
| BR741 | Polyester urethane | Dymax |
| | acrylate | |
| Bisomer PEG200DMA | Polyethylene glycol | Geo Specialty |
| | (200) | |
| | dimethylacrylate | |
| SR508 | Dipropylene glycol | Sartomer |
| | diacrylate | |
| PEGDA SR259 | Polyethylene Glycol | Sartomer |
| | (200) Diacrylate | |
| TEGDMA SR205 | Triethylene Glycol | Sartomer |
| | Dimethacrylate | |
| CAPA SR495B | Polycaprolactone | Sartomer |
| | acrylate | |
| IBOA | Isobornyl acrylate | Evonik |
| HEA | 2-Hydroxyethyl | Sigma Aldrich |
| | acrylate | |
| HPA | Hydroxypropyl | BASF |
| | acrylate | |
| HBA | Hydroxybutyl | TCL |
| | acrylate | |
| Desmodur N3300 | HDI Isocyanurate | Covestro |
| Desmodur N3200 | HDI Biuret | Covestro |
| DBDTL | Dibutyltin dilaurate | Sigma Aldrich |
| Omnirad TPO-L | Photoinitiator | IGM |
| Omnirad 819 | Photoinitiator | IGM |

### Example 1

### Oligomer Synthesis Procedure:

DBDTL and HDI (Desmodur N3300 or N3200) were added in a mixing jar using the amount shown in Table 1 and mixed well with a spatula. Then hydroxy monoacrylate (HEA, HPA, HBA or CAPA) was added into the mixing jar slowly using the amount shown in Table 1 for each reaction. The mixing jar was then put in a 70-80° C. oven and the reaction was allowed to run, with stirring. The presence of isocyanate (NCO) peaks was determined by FTIR to determine when all NCO groups were reacted. The reaction was continued and periodically checked for NCO peaks by FTIR about every 30 minutes, until NCO peaks were no longer detected.

The viscosity of each of the eight synthesized oligomers is shown in Table 2. The two inventive oligomers made from HDI and CAPA (Examples 1 (HDI-CAPA1) and 2 (HDI-CAPA2)) have significantly lower viscosities (37,745 and 33,041) than those made with other oligomers (non-CAPA-containing oligomers) Examples A-F.

TABLE 1

| Example | A | B | C | D | E | F | 1 | 2 |
|---|---|---|---|---|---|---|---|---|
| Oligomer | HDI- | HDI- | HDI- | HDI- | HDI- | HDI- | HDI- | HDI- |
| name | HEA1 | HEA2 | HPA1 | HPA2 | HBA1 | HBA2 | CAPA1 | CAPA2 |
| Desmodur | 63 | | 60 | | 58 | | 36 | |
| N3300 | | | | | | | | |
| Desmodur | | 62 | | 58 | | 57 | | 35 |
| N3200 | | | | | | | | |
| DBDTL | 0.05 | 0.05 | 0.05 | 0.05 | 0.05 | 0.05 | 0.05 | 0.05 |
| HEA | 37 | 38 | | | | | | |
| HPA | | | 40 | 42 | | | | |
| HBA | | | | | 42 | 43 | | |
| CAPA-1* | | | | | | | 64 | 65 |
| Total | 100 | 100 | 100 | 100 | 100 | 100 | 100 | 100 |

*as defined above

TABLE 2

| Examples | A | B | C | D | E | F | 1 | 2 |
|---|---|---|---|---|---|---|---|---|
| Viscosity | 11, 138, | 633, | 611, | 361, | 148, | 109, | 37, | 33, |
| (cPs) at | 800 | 760 | 380 | 660 | 620 | 330 | 745 | 041 |
| 25C 10s-1 | | | | | | | | |

### Example 2

Light curable acrylate compositions were prepared by separately mixing the eight synthesized oligomers (Examples 1.1-1.8) with a polyethylene glycol dimethacrylate monomer PEG200DMA and photoinitiators, respectively, according to the formulations in Table 3. Properties of these compositions and their cured reaction products including viscosity, hardness and lap shear strength are summarized in Table 4. The inventive compositions are represented by Examples 3 and 4. Compositions G-L were comparative Examples.

TABLE 3

| | | | | | | | 3 | 4 |
|---|---|---|---|---|---|---|---|---|
| Example | G | H | I | J | K | L | Inventive | Inventive |
| HDI-HEA1 | 50 | | | | | | | |
| HDI-HEA2 | | 50 | | | | | | |
| HDI-HPA1 | | | 50 | | | | | |
| HDI-HPA2 | | | | 50 | | | | |
| HDI-HBA1 | | | | | 50 | | | |
| HDI-HBA2 | | | | | | 50 | | |
| HDI-CAPA1 | | | | | | | 50 | |
| HDI-CAPA2 | | | | | | | | 50 |
| PEG200DMA | 48 | 48 | 48 | 48 | 48 | 48 | 48 | 48 |
| Omnirad | 1 | 1 | 1 | 1 | 1 | 1 | 1 | 1 |
| 819 | | | | | | | | |
| Omnirad | 1 | 1 | 1 | 1 | 1 | 1 | 1 | 1 |
| TPO-L | | | | | | | | |
| Total | 100 | 100 | 100 | 100 | 100 | 100 | 100 | 100 |

TABLE 4

| | | | | | | | 3 | 4 |
|---|---|---|---|---|---|---|---|---|
| Example | G | H | I | J | K | L | Inventive | Inventive |
| Viscosity | 623 | 634 | 678 | 664 | 516 | 513 | 420 | 425 |
| (cPs) at 25C | | | | | | | | |
| 10s-1 | | | | | | | | |
| Shore D | 80 | 81 | 80 | 81 | 80 | 78 | 78 | 78 |
| PC/PC Lap | 3.06 ± 0.6 | 1.64 ± 0.3 | 2.86 ± 0.5 | 2.32 ± 0.3 | 3.80 ± 0.5 | 2.48 ± 0.7 | 4.56 ± 0.5 | 4.59 ± 1.0 |
| shear | | | | | | | | |
| strength | | | | | | | | |
| (MPa) | | | | | | | | |
| PC/PVC Lap | 2.04 ± 0.95 | 2.89 ± 0.64 | 2.38 ± 0.47 | 3.09 ± 0.83 | 3.09 ± 0.59 | 4.38 ± 0.65 | 6.13 ± 0.97 | 5.64 ± 1.63 |
| shear | | | | | | | | |
| strength | | | | | | | | |
| (MPa) | | | | | | | | |
| Extracted¹ | | | | | | | ND1 | ND |

¹low Mw (meth) acrylate monomers and compounds from monomers (ppm)
ND = none detected

Inventive Examples 3 and 4 containing oligomers HDI-CAPA-1 and HDI-CAPA-2 exhibited relatively lower viscosity and cured hardness as compared to Examples G-L. As seen from the table, polycarbonate/polycarbonate (PC/PC) and polycarbonate/polyvinylchloride (PC/PVC) lap shear strengths using the inventive composition were significantly higher than the comparative other examples. Examples 3 and 4 also had no detectable low molecular weight (meth)acrylate monomer extractables.

Table 5 lists two additional bonding strengths of using the light cured inventive compositions Examples 3 and 4. As shown in Table 5, the bonding strengths on PC/ABS and PC/epoxy G10 FR4 are all comparable to the desirably higher lap shear strengths of PC/PC and PC/PVC.

TABLE 5

| Example | 3 Inventive | 4 Inventive |
|---|---|---|
| PC/ABS Lap shear | 4.64 ± 0.1 | 4.43 ± 0.6 |
| strength (MPa) | | |
| PC/EPOXY G10 FR4 Lap | 5.60 ± 0.7 | 5.31 ± 0.7 |
| shear strength (MPa) | | |

### Comparative Example 3

Light cure acrylate compositions were prepared using two commercially available aliphatic urethane triacrylate oligomers, Photomer 6019 and Photomer 6008, and one commercially available polyester urethane acrylate. These were separately mixed with a polyethylene glycol dimethacrylate monomer PEG200DMA and photoinitiators, respectively, according to the formulation in Table 6. The oligomers Photomer 6019, Photomer 6008 and the polyester urethane acrylate are not synthesized using a caprolactone monomer. Properties of these compositions, including viscosity, hardness and lap shear strength are summarized in Table 7.

TABLE 6

| Comparative | | | |
|---|---|---|---|
| Examples | M | N | O |
| Photomer 6019 | 50 | | |
| Photomer 6008 | | 50 | |
| BR741 | | | 50 |
| PEG200DMA | 48 | 48 | 48 |
| Omnirad 819 | 1 | 1 | 1 |
| Omnirad TPO-L | 1 | 1 | 1 |
| Total | 100 | 100 | 100 |

TABLE 7

| Comparative | | | |
|---|---|---|---|
| Examples | M | N | O |
| Viscosity | 359 | 1060 | 884 |
| (Cps) | | | |
| Shore D | 82 | 80 | 80 |
| PC/PC Lap | 3.01 ± 0.4 | 3.01 ± 0.4 | 3.01 ± 0.4 |
| shear strength | | | |
| (MPa) | | | |
| PC/PVC Lap | 3.41 ± 0.4 | 2.83 ± 0.5 | 1.65 ± 0.4 |
| shear strength | | | |
| (MPa) | | | |

Comparative Example M had similar hardness and somewhat lower viscosity than inventive examples Example 3 to 4. However, the PC/PC and PC/PVC lap shear strengths for comparative Example M was significantly lower than the inventive Examples 3 AND 4. Comparative Examples N AND O have similar hardness but much higher viscosities than inventive examples Example 3 AND 4. Their PC/PC and PC/PVC lap shear strengths were significantly lower than the inventive Examples 3 AND 4.

### Comparative Example 4

Light cure acrylate compositions were prepared by separately mixing three additional (non-CAPA) monomers with HDI-CAPA-1 and HDI-CAPA-2 and photoinitiators, respectively, according to the formulation in Table 8. Properties of these compositions including viscosity, hardness and lap shear strength were summarized in Table 9.

TABLE 8

| | | | 7 | 8 | 9 | 10 |
|---|---|---|---|---|---|---|
| Examples | 5 | 6 | Inventive | Inventive | Inventive | Inventive |
| HDI-CAPA1 | 50 | | 50 | | 50 | |
| HDI-CAPA2 | | 50 | | 50 | | 50 |
| PEGDA | 48 | 48 | | | | |
| SR259 | | | | | | |
| TEGDMA | | | 48 | 48 | | |
| SR205 | | | | | | |
| IBOA | | | | | 48 | 48 |
| Omnirad | 1 | 1 | 1 | 1 | 1 | 1 |
| 819 | | | | | | |
| Omnirad | 1 | 1 | 1 | 1 | 1 | 1 |
| TPO-L | | | | | | |
| Total | 100 | 100 | 100 | 100 | 100 | 100 |

TABLE 9

| | | | 7 | 8 | 9 | 10 |
|---|---|---|---|---|---|---|
| Examples | 5 | 6 | Inventive | Inventive | Inventive | Inventive |
| Viscosity | 542 | 576 | 349 | 329 | 506 | 510 |
| (Cps) | | | | | | |
| Shore D | 63 | 60 | 77 | 77 | 67 | 68 |
| PC/PVC Lap | 2.9 ± 0.2 | 3.6 ± 1.7 | 5.1 ± 1.2 | 5.9 ± 0.4 | 4.5 ± 1.2 | 5.7 ± 0.1 |
| shear | | | | | | |
| strength | | | | | | |
| (MPa) | | | | | | |
| Extracted¹ | ND | ND | ND | ND | 213² | 186³ |

¹low Mw (meth) acrylate monomers and compounds from monomers (ppm)
²testing also detected 575 ppm camphene, an impurity in IBOA.
³testing also detected 563 ppm camphene, an impurity in IBOA.

Surprisingly, Examples 5 and 6, which use polyethylene glycol diacrylate (PEGDA) monomer, exhibit much lower hardness and undesirably lower PC/PVC lap shear strengths compared to Examples 3 and 4, which uses PEG200DMA. Examples 7 and 8 use trimethylene glycol dimethacrylate (TEGDMA) monomer and exhibit similar hardness and PC/PVC lap shear strengths as the Examples 3 and 4, which uses PEG200DMA. Examples 5, 6, 7 and 8 also had no detectable low molecular weight (meth)acrylate monomer extractables.

Examples 9 and 10 show that replacing the poly-functional polyether (meth)acrylate monomer with a mono-functional monomer such as IBOA showed lower hardness, but similar PC/PVC lap shear strengths as Examples 3 and 4, demonstrating the need for the poly-functional polyether (meth)acrylate monomer to achieve all of the desired properties. Examples 9 and 10 did show significant levels of low molecular weight (meth)acrylate monomer extractables and impurity compounds of those low molecular weight (meth)acrylate monomers.

### Example 5

Inventive compositions were formulated using different mixing ratios of oligomers HDI-CAPA 1 and HDI-CAPA-2 to the Di-functional monomer PEG200DMA. The compositions were separately mixed with same amount of photoinitiator in each, according to the formulation in Table 10. Properties of these compositions including viscosity, hardness and lap shear strength are summarized in Table 11.

TABLE 10

| Inventive | | | | | | |
|---|---|---|---|---|---|---|
| Examples | 3 | 4 | 11 | 12 | 13 | 14 |
| HDI-CAPA1 | 50 | | 70 | | 30 | |
| HDI-CAPA2 | | 50 | | 70 | | 30 |
| PEGDMA | 48 | 48 | 28 | 28 | 68 | 68 |
| Omnirad | 1 | 1 | 1 | 1 | 1 | 1 |
| 819 | | | | | | |
| Omnirad | 1 | 1 | 1 | 1 | 1 | 1 |
| TPO-L | | | | | | |
| Total | 100 | 100 | 100 | 100 | 100 | 100 |
| oligomer | 50:50 | 50:50 | 70:28 | 70:28 | 30:70 | 30:70 |
| to | | | | | | |
| monomer | | | | | | |
| ratio | | | | | | |

TABLE 11

| Inventive Examples | 3 | 4 | 11 | 12 | 13 | 14 |
|---|---|---|---|---|---|---|
| Viscosity (Cps) | 420 | 425 | 2077 | 2154 | 120 | 105 |
| Shore D | 78 | 78 | 68 | 68 | 76 | 76 |
| PC/PVC Lap shear | 6.13 ± 1.0 | 5.64 ± 1.6 | 4.58 ± 1.4 | 4.85 ± 1.0 | 5.62 ± 1.2 | 4.41 ± 1.2 |
| strength (MPa) | | | | | | |
| Extracted low Mw | ND | ND | ND | ND | ND | ND |
| (meth) acrylate | | | | | | |
| monomers and | | | | | | |
| compounds from | | | | | | |
| monomers (ppm) | | | | | | |

Examples 5.1 and 5.2 which had an oligomer to monomer weight percent mixing ratio of 70/28 demonstrated higher viscosity and lower hardness values than the compositions of Examples 2.7, 2.8, 5.3 and 5.4, where the ratio was about 50/50 or 30/70, respectively. All these examples when tested had similar PC/PVC lap shear strengths.

1. A photo-curable composition comprising:
a) a caprolactone-based polyurethane (meth)acrylate oligomer;
b) a (meth)acrylate monomer; and
c) a photoinitiator;
wherein cured reaction products of the composition have a PC/PC lap shear strength of 4 MPa and/or a PC/PVC lap shear strength of 5 MPa.

2. The photo-curable composition of claim 1 wherein the resultant composition once photo-cured exhibits substantially no low molecular weight (meth)acrylate monomer extractables when tested using a (meth)acrylate monomer extraction test.

3. The photo-curable composition of claim 1 wherein the b) (meth)acrylate monomer is a poly-functional polyether (meth)acrylate monomer.

4. The composition of claim 1, wherein the caprolactone-based polyurethane (meth)acrylate oligomer comprises the reaction product of a mono-(meth)acrylate monomer containing a hydroxyl group and a hexamethylene diisocyanate (HDI) isocyanurate or the reaction product of a mono-(meth)acrylate monomer containing a hydroxyl group and a hexamethylene diisocyanate (HDI) biuret.

5. The composition of claim 1, wherein the caprolactone-based polyurethane (meth)acrylate oligomer is selected from the group consisting of CAPA-1, CAPA-2 or combinations thereof, the structures being set forth below:

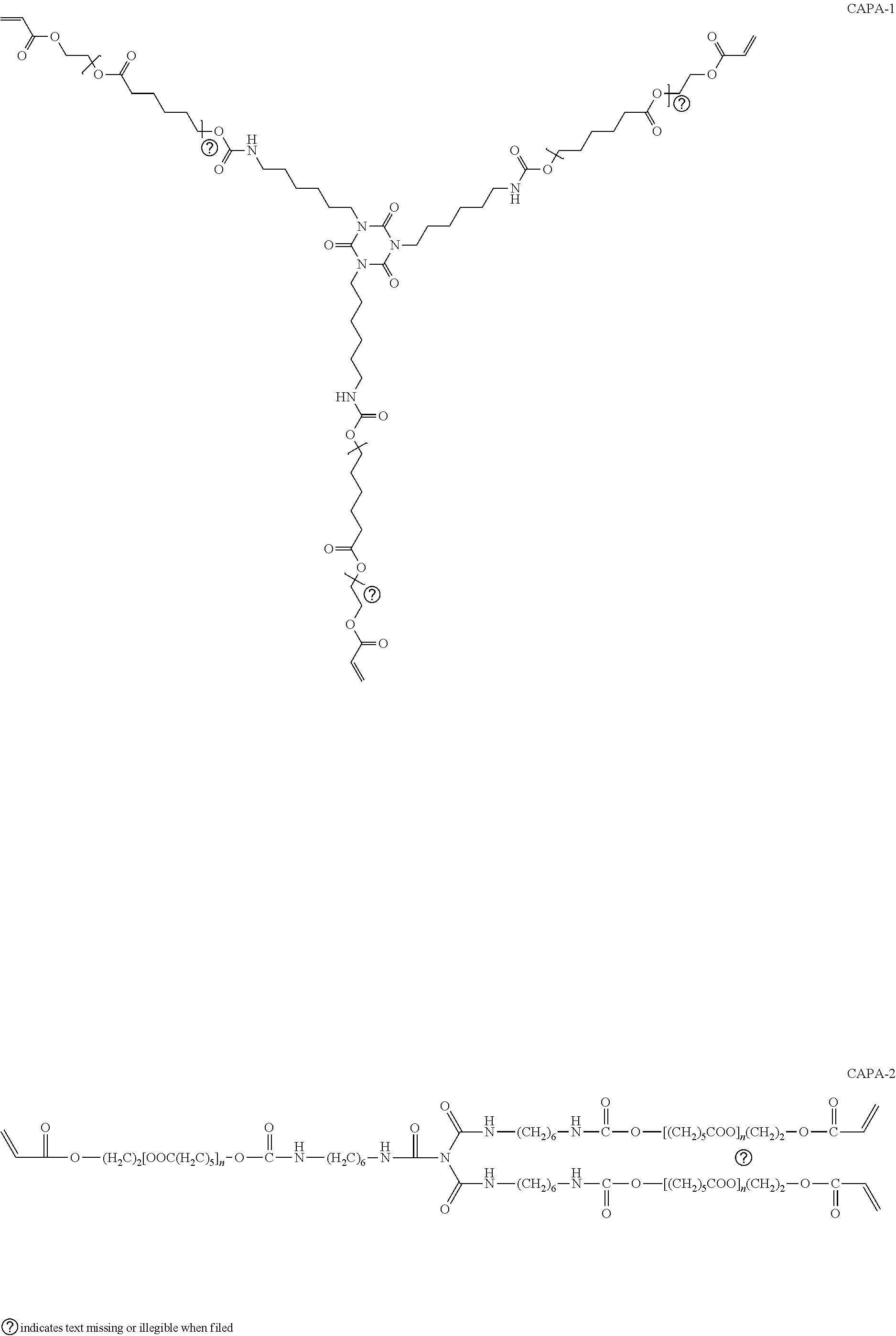

6. The composition of claim 1, wherein the composition further comprises a low molecular weight (meth)acrylate monomer.

7. The composition of claim 1, wherein the composition further comprises 2-hydroxyethylacrylate, hydroxypropylacrylate, hydroxybutylacrylate and combinations thereof.

8. The composition of claim 1, wherein the caprolactone-based polyurethane (meth)acrylate oligomer is present in the amount of about 20% to about 60% by weight of the total composition.

9. The composition of claim 1, wherein the b) (meth)acrylate monomer is a poly-functional polyether (meth)acrylate monomer is selected from the group consisting of polyethylene glycol dimethylacrylate (PEG200 DMA), dipropylene glycol diacrylate and combinations thereof.

10. The composition of claim 1, wherein the b) (meth)acrylate monomer is a poly-functional polyether (meth)acrylate monomer and is present in the amount of about 10% to about 60% by weight of the total composition.

11. The composition of claim 1, wherein the uncured photo-curable composition has a viscosity of about 200 Cps to about 10,000 Cps.

12. The composition of claim 1, wherein the b) (meth)acrylate monomer is a monofunctional (meth)acrylate monomer or a polyfunctional (meth)acrylate monomer.

13. The composition of claim 1, wherein the composition further comprises an additive selected from: fluorescence additive, filler, rheology modifier, photosensitizer, coloring agent, accelerator, adhesion promoter, defoamer, stabilizer, antioxidant and pigment.

14. An article of manufacture comprising:
a first substrate surface; and
the adhesive composition of claim 1 disposed on the first substrate surface.

15. A process of preparing a photo-curable composition comprising:
providing a mono-(meth)acrylate monomer containing a hydroxyl group;
providing a polyisocyanate selected from hexamethylene diisocyanate (HDI) isocyanurate, hexamethylene diisocyanate (HDI) biuret, or a combination thereof;
reacting the mono-(meth)acrylate monomer containing a hydroxyl group and the polyisocyanate to form a caprolactone-based polyurethane (meth)acrylate oligomer; and
combining the caprolactone-based polyurethane (meth)acrylate oligomer with a poly-functional meth)acrylate monomer and a photoinitiator;
wherein cured reaction products of the composition have a PC/PC lap shear strength of 4 MPa and/or a PC/PVC lap shear strength of 5 MPa.

16. The process of claim 15, wherein the poly-functional (meth)acrylate monomer is selected from polyethylene glycol dimethylacrylate (PEG200 DMA), dipropylene glycol diacrylate and combinations thereof.
